(19) United States
(12) Patent Application Publication
(10) Pub. No.: US 2019/0275884 A1
(43) Pub. Date: Sep. 12, 2019

(54) ELECTRIC AXLE WITH VARIABLE RATIO, A HIGH EFFICIENCY LOCK UP RATIO, A NEUTRAL

(71) Applicant: Dana Limited, Maumee, OH (US)

(72) Inventors: Jeffrey M. David, Cedar Park, TX (US); Gordon M. McIndoe, Volente, TX (US); Travis J. Miller, Cedar Park, TX (US); Sebastian J. Peters, Cedar Park, TX (US); Patrick R. Sexton, Austin, TX (US)

(21) Appl. No.: 16/277,268

(22) Filed: Feb. 15, 2019

Related U.S. Application Data
(60) Provisional application No. 62/639,011, filed on Mar. 6, 2018.

(51) Int. Cl. B60K 17/04; B60K 7/00; F16H 15/40

(52) U.S. Cl. CPC B60K 17/046; F16H 15/40; B60K 7/0007

(57) ABSTRACT

Provided herein is an electric axle powertrain includind: a continuously variable electric drivetrain having a motor/generator and a ball-type continuously variable planetary having a first traction ring assembly and a second traction ring assembly in contact with a plurality of balls; a mode selection mechanism coupled to the continuously variable electric drivetrain; a differential coupled to the mode selection mechanism; a drive wheel axle operably coupled to the differential; and-a first wheel and a second wheel coupled to the drive wheel axle.

### RELATED APPLICATION

This application claims the benefit and priority of U.S. Provisional Application Ser. No. 62/639,011 filed on Mar. 6, 2018, which is incorporated by reference in its entirety herein.

### BACKGROUND

Hybrid vehicles are enjoying increased popularity and acceptance due in large part to the cost of fuel and greenhouse carbon emission government regulations for internal combustion engine vehicles. Such hybrid vehicles include both an internal combustion engine as well as an electric motor to propel the vehicle.

In current electric axle designs for both consuming as well as storing electrical energy, the rotary shaft from a combination electric motor/generator is coupled by a gear train, planetary gear set, to the wheel. As such, the rotary shaft for the electric motor/generator unit rotates in unison with the wheel based on the speed ratio of the gear train.

These fixed ratio designs have many disadvantages, for example, the electric motor/generator unit achieves its most efficient operation, both in the sense of generating electricity and also providing additional power to the wheel or the main shaft of the internal combustion engine, only within a relatively narrow range of revolutions per minute of the motor/generator unit. As such, the overall electric or hybrid electric vehicle operates at less than optimal efficiency over a drive cycle. Therefore, there is a need for powertrain configurations that improve the efficiency of electric and hybrid electric vehicles.

### SUMMARY

Provided herein is an electric axle powertrain including: a continuously variable electric drivetrain including a motor/generator and a ball-type continuously variable planetary having a first traction ring assembly and a second traction ring assembly in contact with a plurality of balls; a mode selection mechanism coupled to the continuously variable electric drivetrain; a differential coupled to the mode selection mechanism; a drive wheel axle operably coupled to the differential; and a first wheel and a second wheel coupled to the drive wheel axle.

In some embodiments, the mode selection mechanism is configured to disengage the differential from the continuously variable electric drivetrain.

In some embodiments, the mode selection mechanism is configured to selectively couple to the continuously variable electric drivetrain to provide a fixed ratio coupling and a variable ratio coupling.

In some embodiments, the electric axle power train further includes a planetary gear set coupled to the continuously variable planetary, the planetary gear set including a ring gear coupled to the mode selection mechanism, a planet carrier adapted to receive a rotational power, the planet carrier coupled to the first traction ring assembly, and a sun gear coupled to the second traction ring assembly.

Provided herein is an electric axle powertrain including: a continuously variable electric drivetrain including a motor/generator and a ball-type continuously variable planetary having a first traction ring assembly and a second traction ring assembly in contact with a plurality of balls; a differential coupled to the continuously variable electric drivetrain; a drive wheel axle operably coupled to the differential; a first wheel and a second wheel coupled to the drive wheel axle; and a planetary gear set coupled to the continuously variable planetary, the planetary gear set including a ring gear coupled to the second traction ring assembly, a planet carrier adapted to receive a rotational power, and a sun gear coupled to the first traction ring assembly.

In some embodiments, the electric axle powertrain further includes a transfer gear set having a first transfer gear operably coupled to the planetary gear set and a second transfer gear operably coupled to the differential.

In some embodiments, the electric axle powertrain further includes an engagement collar operably coupled to the first transfer gear, the ring gear, and the planet carrier.

In some embodiments, the engagement collar is adapted to move axially.

In some embodiments, the engagement collar is an annual ring having an inner bore, wherein the inner bore is provided with a first array of engagement splines and a second array of engagement splines.

In some embodiments, the first transfer gear is provided with a first array of engagement teeth adapted to interlock with the first array of engagement splines and the second array of engagement splines of the engagement collar.

In some embodiments, the ring gear is provided with a second array of engagement teeth located on an outer periphery of the ring gear, wherein the second array of engagement teeth are configured to interlock with the first array of engagement splines and the second array of engagement splines of the engagement collar.

In some embodiments, the planet carrier is provided with a third array of engagement teeth located on an outer periphery of the planet carrier, wherein the third array of engagement teeth are configured to interlock with the first array of engagement splines and the second array of engagement splines of the engagement collar.

In some embodiments, the electric axle powertrain operates in a neutral operating condition when the engagement collar is decoupled from the first transfer gear.

In some embodiments, the electric axle powertrain operates in a fixed ratio operating mode when the engagement collar is coupled to first transfer gear, the ring gear, and the planet carrier.

In some embodiments, the electric axle powertrain operates in a variable ratio operating mode when he engagement collar is coupled to the first transfer gear and the ring gear.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

Novel features of the preferred embodiments are set forth with particularity in the appended claims. A better understanding of the features and advantages of the present embodiments will be obtained by reference to the following detailed description that sets forth illustrative embodiments, in which the principles of the preferred embodiments are utilized, and the accompanying drawings of which:

FIG. 1 is a side sectional view of a ball-type variator.

FIG. 2 is a plan view of a carrier member that is used in the variator of FIG. 1.

FIG. 3 is an illustrative view of different tilt positions of the ball-type variator of FIG. 1.

FIG. 4 is a schematic diagram of an electric axle powertrain having a continuously variable electric drivetrain drivingly engaged to a differential, axle, and wheels of a vehicle.

FIG. 5 is a schematic diagram of an electric axle powertrain having a continuously variable electric drivetrain drivingly engaged with a variable power path and a fixed ratio power path to a differential, axle, and wheels of a vehicle.

FIG. 6 is a partial cross-sectional view of an electric axle powertrain having a continuously variable electric drivetrain.

FIG. 7 is a cross-sectional view of a variable ratio setting of a planetary gear set and engagement collar implemented in the electric axle powertrain of FIG. 6.

FIG. 8 is cross-sectional view of a fixed ratio setting of a planetary gear set and engagement collar implemented in the electric axle powertrain of FIG. 6.

FIG. 9 is a cross-sectional view of a neutral setting of a planetary gear set and engagement collar implemented in the electric axle powertrain of FIG. 6.

FIG. 10 is an exploded isometric view of the planetary gear set and engagement collar implemented in the electric axle powertrain of FIG. 6.

FIG. 11 is a schematic diagram of a powersplit variator that is implementable in the electric axle powertrains of FIG. 4-6.

FIG. 12 is a schematic diagram of a variator that is implementable in the electric axle powertrain of FIGS. 4-6.

FIG. 13 is a schematic diagram of a variator configured as an inverse regenerated variator that is implementable in the electric axle powertrains of FIGS. 4-6.

### DETAILED DESCRIPTION OF THE PREFERRED EMBODIMENTS

The preferred embodiments will now be described with reference to the accompanying figures, wherein like numerals refer to like elements throughout. The terminology used in the descriptions below is not to be interpreted in any limited or restrictive manner simply because it is used in conjunction with detailed descriptions of certain specific embodiments. Furthermore, the preferred embodiments includes several novel features, no single one of which is solely responsible for its desirable attributes or which is essential to practicing the embodiments described.

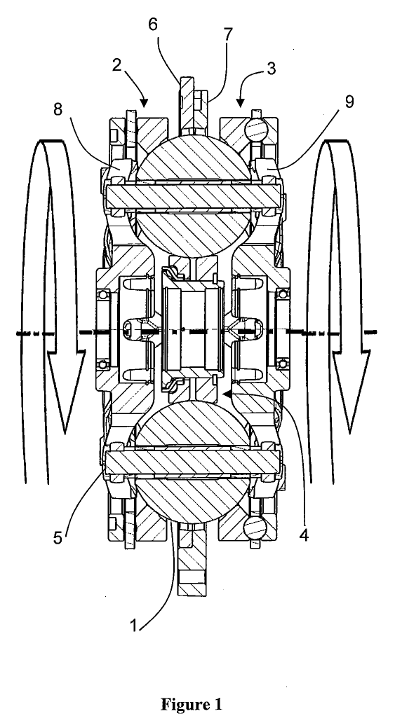

Provided herein are configurations of CVTs based on a ball-type variator, also known as CVP, for continuously variable planetary. Basic concepts of a ball-type Continuously Variable Transmissions are described in U.S. Pat. Nos. 8,469,856 and 8,870,711 incorporated herein by reference in their entirety. Such a CVT, adapted herein as described throughout this specification, includes a number of balls (planets, spheres) 1, depending on the application, two ring (disc) assemblies with a conical surface in contact with the balls, an input (first) traction ring 2, an output (second) traction ring 3, and an idler (sun) assembly 4 as shown on FIG. 1. The balls are mounted on tiltable axles 5, themselves held in a carrier (stator, cage) assembly having a first carrier member 6 operably coupled to a second carrier member 7. The first carrier member 6 rotates with respect to the second carrier member 7, and vice versa.

In some embodiments, the first carrier member 6 is fixed from rotation while the second carrier member 7 is configured to rotate with respect to the first carrier member, and vice versa.

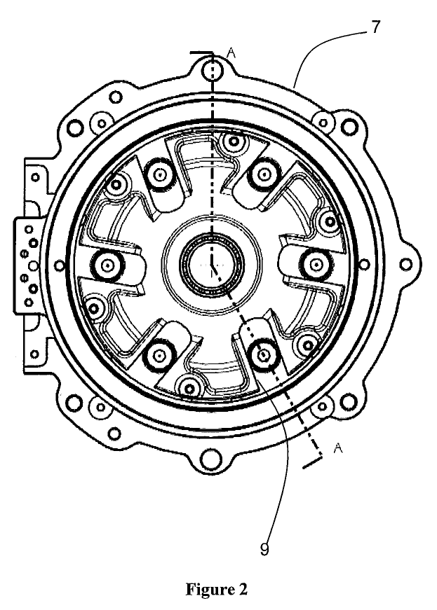

In one embodiment, the first carrier member 6 is provided with a number of radial guide slots 8. The second carrier member 7 is provided with a number of radially offset guide slots 9, as illustrated in FIG. 2. The radial guide slots 8 and the radially offset guide slots 9 are adapted to guide the tiltable axles 5.

The axles 5 are adjusted to achieve a desired ratio of input speed to output speed during operation of the CVT.

In some embodiments, adjustment of the axles 5 involves control of the position of the first and second carrier members to impart a tilting of the axles 5 and thereby adjusts the speed ratio of the variator. Other types of ball CVTs also exist, but are slightly different.

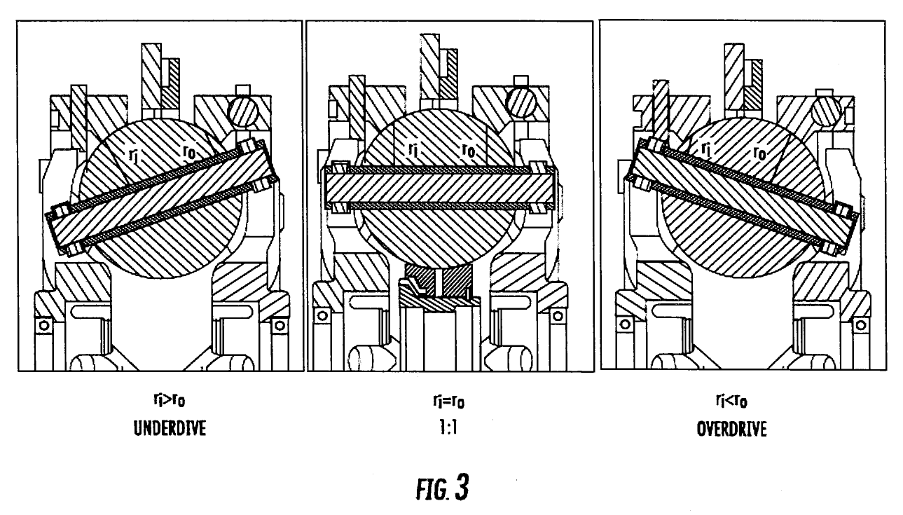

The working principle of such a CVP of FIG. 1 is shown on FIG. 3. The CVP itself works with a traction fluid. The lubricant between the ball and the conical rings acts as a solid at high pressure, transferring the power from the input ring, through the balls, to the output ring. By tilting the balls' axes, the ratio is changed between input and output. When the axis is horizontal the ratio is one, illustrated in FIG. 3, when the axis is tilted the distance between the axis and the contact point change, modifying the overall ratio. All the balls' axes are tilted at the same time with a mechanism included in the carrier and/or idler. Embodiments disclosed here are related to the control of a variator and/or a CVT using generally spherical planets each having a tiltable axis of rotation that are adjusted to achieve a desired ratio of input speed to output speed during operation.

In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”.

In some embodiments, a control system coordinates the use of a skew angle to generate forces between certain contacting components in the variator that will tilt the planet axis of rotation. The tilting of the planet axis of rotation adjusts the speed ratio of the variator.

For description purposes, the term “radial” is used here to indicate a direction or position that is perpendicular relative to a longitudinal axis of a transmission or variator. The term “axial” as used here refers to a direction or position along an axis that is parallel to a main or longitudinal axis of a transmission or variator. For clarity and conciseness, at times similar components labeled similarly (for example, bearing 1011A and bearing 1011B) will be referred to collectively by a single label (for example, bearing 1011).

As used here, the terms “operationally connected,” “operationally coupled”, “operationally linked”, “operably connected”, “operably coupled”, “operably linked,” “operably coupleable” and like terms, refer to a relationship (mechanical, linkage, coupling, etc.) between elements whereby operation of one element results in a corresponding, following, or simultaneous operation or actuation of a second element. It is noted that in using said terms to describe the embodiments, specific structures or mechanisms that link or couple the elements are typically described. However, unless otherwise specifically stated, when one of said terms is used, the term indicates that the actual linkage or coupling take a variety of forms, which in certain instances will be readily apparent to a person of ordinary skill in the relevant technology.

It should be noted that reference herein to “traction” does not exclude applications where the dominant or exclusive mode of power transfer is through “friction.” Without attempting to establish a categorical difference between traction and friction drives here, generally these are typically understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction force which would be available at the interfaces of the contacting components and is the ratio of the maximum available drive torque per contact force. Typically, friction drives generally relate to transferring power between two elements by frictional forces between the elements. For the purposes of this disclosure, it should be understood that the CVTs described here operate in both tractive and frictional applications. For example, in the embodiment where a CVT is used for a bicycle application, the CVT operates at times as a friction drive and at other times as a traction drive, depending on the torque and speed conditions present during operation.

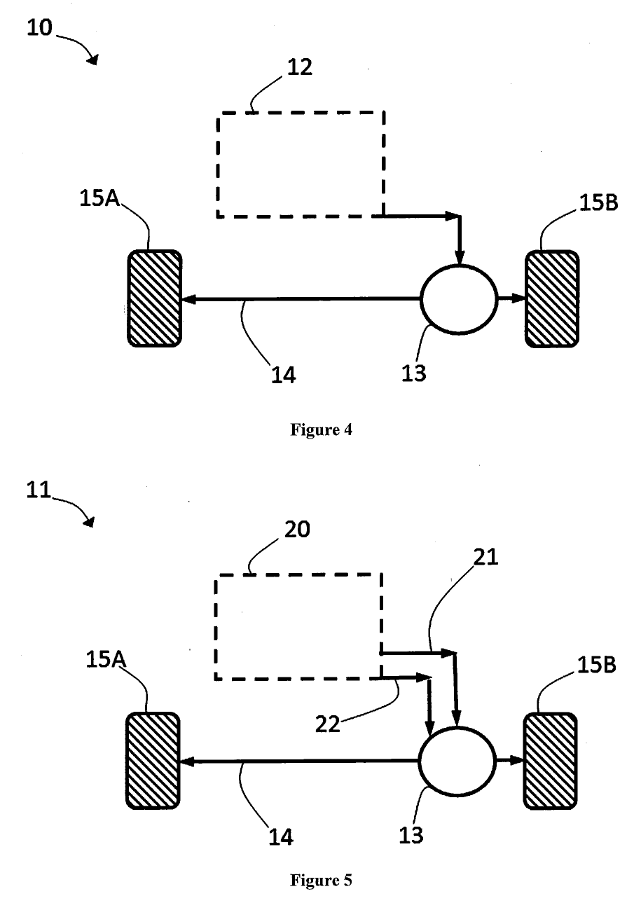

Referring to FIG. 4, in some embodiments, an electric axle powertrain 10 includes a continuously variable electric drivetrain 12 operably coupled to a differential 13. It should be appreciated that the differential 13 is a mechanical device used to distribute torque and/or speed to drive wheels, and can have a variety of forms.

In some embodiments, the differential 13 is a common differential gear set implemented to transmit rotational power. The differential 13 is operably coupled to a wheel drive axle 14 configured to drive a set of vehicle wheels 15 attached the axial ends thereof (labeled as “15A” and “15B” in FIG. 4). Illustrative embodiments of the continuously variable electric drivetrain 12 are depicted in Patent Cooperation Treaty Application Numbers PCT/US17/49521, PCT/US17/049534, and PCT/US17/049567, which are hereby incorporated by reference in their entirety.

Referring now to FIG. 5, in some embodiments, an electric axle powertrain 11 includes a continuously variable electric drivetrain 20 operably coupled to a differential 13. The differential 13 is operably coupled to a wheel drive axle 14 configured to drive the set of vehicle wheels 15 attached to the axial ends thereof.

In some embodiments, the continuously variable electric drivetrain 20 is operably coupled to the differential 13 to provide two paths of power transmission to the differential 13. A first powerpath coupling 21 is adapted to provide a variable ratio. A second powerpath coupling 22 is adapted to provide a fixed ratio. In some embodiments, the second powerpath coupling 22 is considered a higher efficiency path.

In some embodiments, the first powerpath coupling 21, sometimes referred to herein as “the variable powerpath” or “the variable path”, is implemented to provide an extended range in the overdrive condition of a vehicle. An example of this condition is a vehicle traveling down a hill or grade and the variable path provides an overdrive ratio that allows the electric motor to maintain a more efficient operating condition.

In some embodiments, the first powerpath coupling 21 is implemented to provide an extended underdrive range for the vehicle for condition such as towing or low speed crawling operation.

Configurations of electric axles having multiple paths of power transmission to the differential 13 from the continuously variable electric drivetrain 20 will be described herein.

In some embodiments, the electric axle powertrain 11 includes a mode selection mechanism positioned between the continuously variable electric drivetrain 20 and the differential 13 configured to select between the fixed ratio path and the variable path.

In some embodiments, the mode selection mechanism is configured to disengage the continuously variable electric drivetrain 20 from the differential 13 for a neutral operating condition.

In some embodiments, the mode selection mechanism includes a clutch.

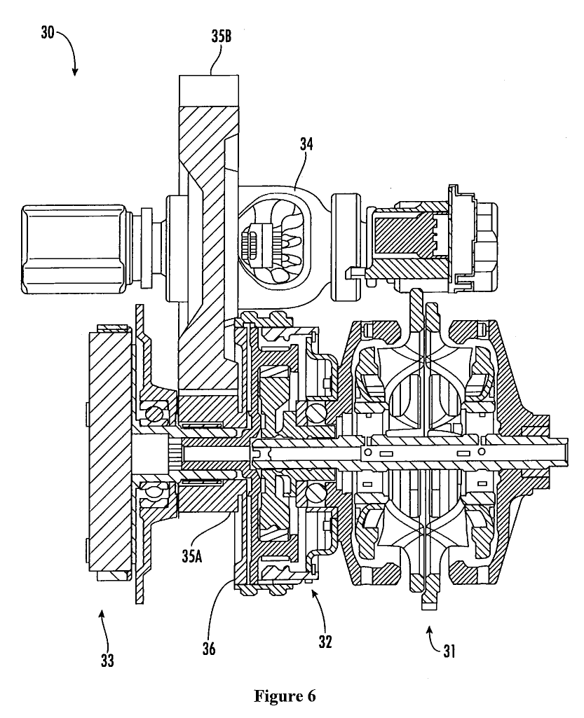

Turning now to FIG. 6, in some embodiments, an electric axle powertrain 30 includes a variator 31 coupled to a planetary gear set 32 and an electric motor/generator 33. In some embodiments, the variator 31 is similar to the variator depicted in FIGS. 1-3.

The electric axle powertrain 30 is provided with a differential 34 configured to be coaxial with a final drive axle of a vehicle (not shown). In some embodiments, the differential 34 is operably coupled through a transfer gear 35 to the planetary gear set 32.

In some embodiments, the transfer gear set 35 includes a set of meshing gears, a first transfer gear 35A aligned with the axis of the planetary gear set 32, and a second transfer gear 35B aligned with the axis of the differential 34. It should be appreciated that there are a number of known couplings that are represented by the transfer gear set 35.

In some embodiments, the planetary gear set 32 is coupled to an engagement collar 36.

During operation of the electric axle powertrain 30, the engagement collar 36 is adjusted axially with respect to the planetary gear set 32 by an actuator (not shown).

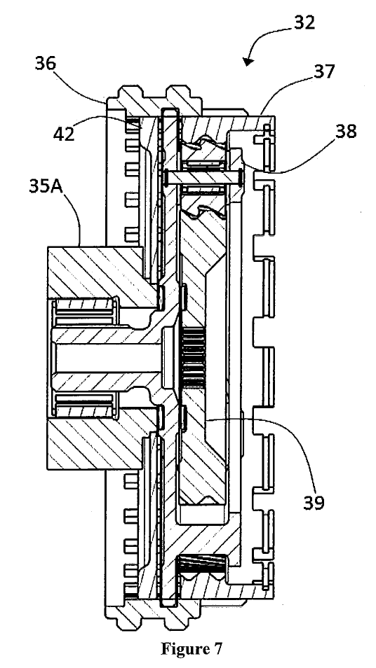

Referring now to FIGS. 7-9, in some embodiments, the planetary gear set 32 includes a ring gear 37, a planet carrier 38, and a sun gear 39.

In some embodiments, the engagement collar 36 is positioned radially outward of the planetary gear set 32. In some embodiments, the engagement collar 36 is located radially inward of the planetary gear set 32.

In some embodiments, the engagement collar 36 is adapted to selectively couple to the ring gear 37 and the planet carrier 38 by adjustment of the axial position of the engagement collar 36 with respect to the planetary gear set 32.

For example, the engagement collar 36 is depicted in a variable ratio position in FIG. 7. In some embodiments, the variable ratio position corresponds to the engagement collar 36 coupled to the first transfer gear 35A and the ring gear 37.

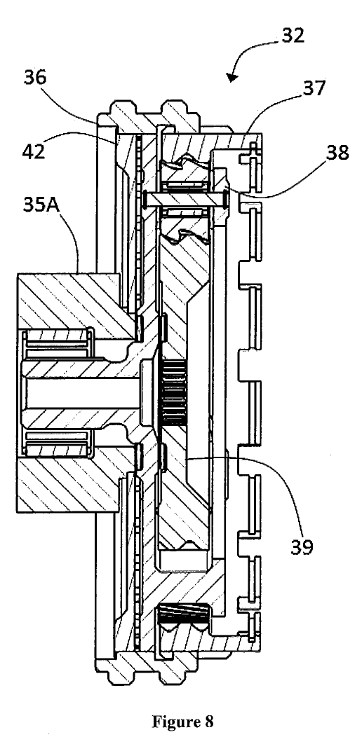

The engagement collar 36 is depicted engaged in a fixed ratio position in FIG. 8. In some embodiments, the fixed ratio position corresponds to a 1:1 operating condition of the variator 31. In some embodiments, the fixed ratio position corresponds to the engagement collar 36 coupled to the first transfer gear 35A, the ring gear 37, and the planet carrier 38.

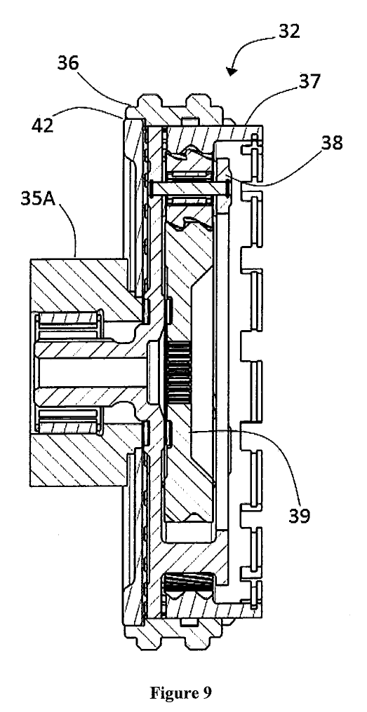

The engagement collar 36 is depicted engaged in a disengaged position in FIG. 9.

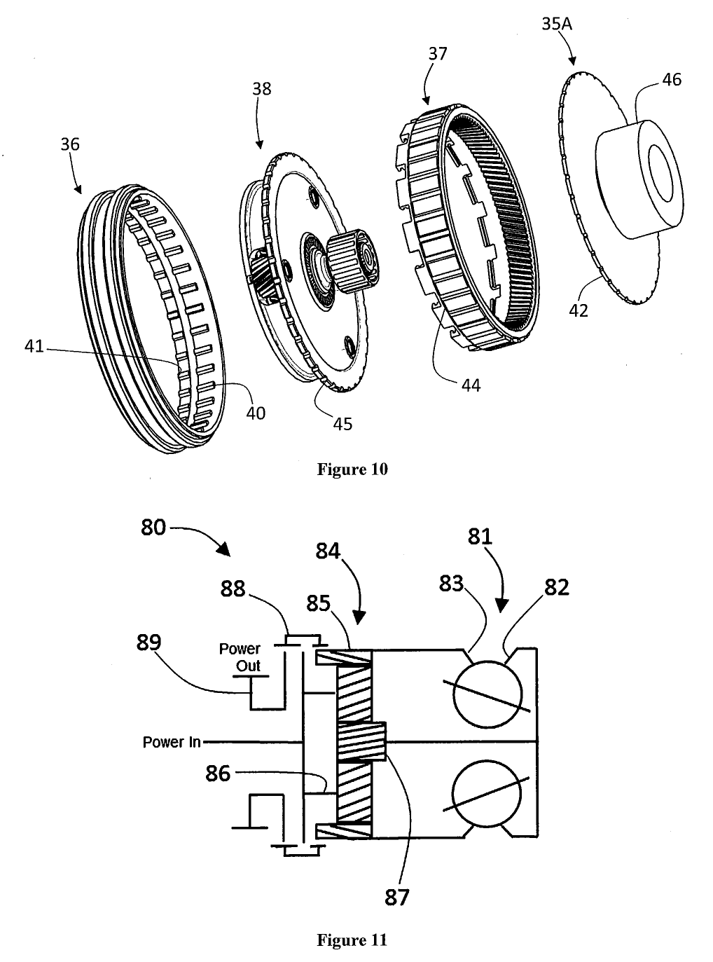

Referring now to FIG. 10, in some embodiments, the engagement collar 36 is a generally annual ring having an outer periphery and an inner bore. The engagement collar 36 is provided with a first array of engagement splines 40 and a second array of engagement splines 41 each located on the inner bore.

In some embodiments, the first transfer gear 35A includes a first array of engagement teeth 42 adapted to interlock with the first array of engagement splines 40 and the second array of engagement splines 41.

In some embodiments, the first array of engagement teeth 42 are located radially outward of an array of meshing gear teeth 46. It should be appreciated that the first array of engagement teeth 42 are different from the array of meshing gear teeth 46 that are configured to couple to the second transfer gear 35B.

In some embodiments, the ring gear 37 is a generally annular ring having an outer periphery and an inner bore. The ring gear 37 is provided with a second array of engagement teeth 44 arranged on the outer periphery. The second array of engagement teeth 44 are configured to interlock with the first array of engagement splines 40 and the second array of engagement splines 41.

In some embodiments, the planet carrier 38 is provided with a third array of engagement teeth 45 located on the outer periphery of the planet carrier 38 and adapted to interlock with the first array of engagement spline 40 and the second array of engagement splines 41.

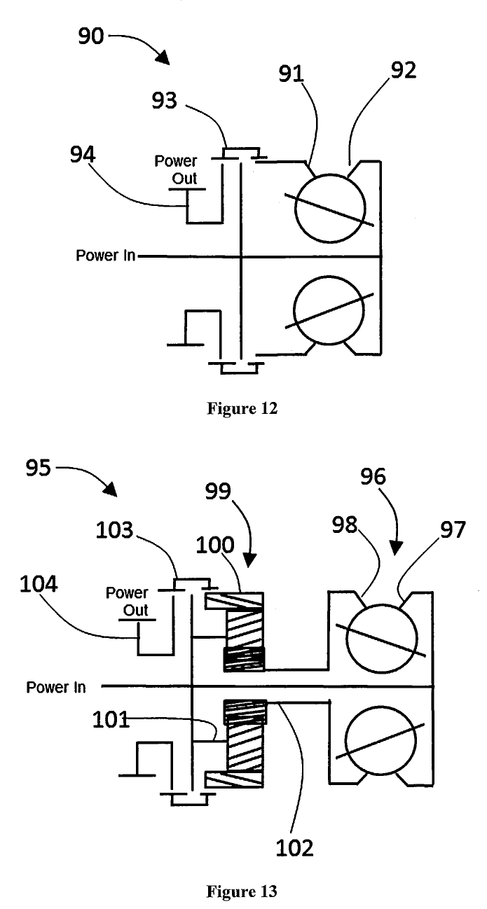

Referring now to FIGS. 11 and 12, it should be noted that the variator 31 and the planetary gear set 32 are optionally configured to include alternative or additional gearing or clutches to provide additional ratio range or modes of operation. For example, a variator 80 includes a continuously variable planetary (CVP) 81 that is similar to the variator described in FIGS. 1-3. The CVP 81 has a first traction ring assembly 82 and a second traction ring assembly 83. In some embodiments, the CVP 81 includes a planetary gear set 84 having a ring gear 85 coupled to the second traction ring assembly 83, a planet carrier 86 supporting a number of planet gears, and a sun gear 87 coupled to the first traction ring assembly 82. It should be appreciated that the planetary gear set 84 is optionally configured to be a fixed ratio traction planetary. The variator 80 is provided with a mode selection mechanism 88 adapted to selectively, couple to the ring gear 85, the planet carrier 86, and an output transfer gear 89. Power is transmitted from a rotational power source to the planet carrier 86. Power is transmitted out of the variator 80 through the output transfer gear 89. A variable ratio mode of operation corresponds to the mode selection mechanism 88 coupled to the output transfer gear 89 and the ring gear 85. A fixed ratio mode of operation corresponds to the mode selection mechanism 88 coupled to the output transfer gear 89, the ring gear 85, and the planet carrier 86. A disengaged or neutral mode of operation corresponds to the mode selection mechanism 88 uncoupled to the components of the variator 80.

In some embodiments, a variator 90 is similar to the variator depicted in the FIGS. 1-3. The variator 90 has a first traction ring assembly 91 and a second traction ring assembly 92. Power is transmitted into the variator 90 through the second traction ring assembly 92. The variator 90 is provided with a mode selection mechanism 93 adapted to selectively couple to the first traction ring assembly 91, the second traction ring 92, and an output transfer gear 94. Power is transmitted out of the variator 90 through the output transfer gear 94. A variable ratio mode of operation corresponds to the mode selection mechanism 93 coupled to the output transfer gear 94 and the first traction ring assembly 91. A fixed ratio mode of operation corresponds to the mode selection mechanism 93 coupled to the output transfer gear 94, the first traction ring assembly 91, and the second traction ring assembly 92. A disengaged or neutral mode of operation corresponds to the mode selection mechanism 93 uncoupled to the output transfer gear 94.

Referring now to FIG. 13, it should be noted that the variator 31 and the planetary gear set 32 are optionally configured to include additional gearing or clutches to provide additional ratio range or modes of operation.

In some embodiments, the variators are configured as an inverse regenerative variator 95. For example, the variator 95 includes a continuously variable planetary (CVP) 96 that is similar to the variator described in FIGS. 1-3. The CVP 96 has a first traction ring assembly 97 and a second traction ring assembly 98.

In some embodiments, the variator 95 includes a planetary gear set 99 having a ring gear 100, a planet carrier 101 supporting a number of planet gears, and a sun gear 102 coupled to the second traction ring assembly 98. The planet carrier 101 is operably coupled to the first traction ring assembly 97. It should be appreciated that the planetary gear set 99 is optionally configured to be a fixed ratio traction planetary. The variator 95 is provided with a mode selection mechanism 103 adapted to selectively couple to the ring gear 100, the planet carrier 101, and an output transfer gear 104. Power is transmitted from a rotational power source to the planet carrier 101. Power is transmitted out of the variator 95 through the output transfer gear 104. A variable ratio mode of operation corresponds to the mode selection mechanism 103 coupled to the output transfer gear 104 and the ring gear 100. A fixed ratio mode of operation corresponds to the mode selection mechanism 103 coupled to the output transfer gear 104, the ring gear 100, and the planet carrier 101. A disengaged or neutral mode of operation corresponds to the mode selection mechanism 103 uncoupled to the output transfer gear 104.

While preferred embodiments have been shown and described herein, it will be obvious to those skilled in the art that such embodiments are provided by way of example only. Numerous variations, changes, and substitutions will now occur to those skilled in the art without departing from the preferred embodiments. It should be understood that various alternatives to the embodiments described herein may be employed in practice. It is intended that the following claims define the scope of the preferred embodiments and that methods and structures within the scope of these claims and their equivalents be covered thereby.

What is claimed is:

1. An electric axle powertrain comprising:
a continuously variable electric drivetrain comprising a motor/generator and a ball-type continuously variable planetary having a first traction ring assembly and a second traction ring assembly in contact with a plurality of balls;
a mode selection mechanism coupled to the continuously variable electric drivetrain;
a differential coupled to the mode selection mechanism;
a drive wheel axle operably coupled to the differential; and
a first wheel and a second wheel coupled to the drive wheel axle.

2. The electric axle powertrain of claim 1, wherein in the mode selection mechanism is configured to disengage the differential from the continuously variable electric drivetrain.

3. The electric axle powertrain of claim 1, wherein the mode selection mechanism is configured to selectively couple to the continuously variable electric drivetrain to provide a fixed ratio coupling and a variable ratio coupling.

4. An electric axle powertrain comprising:
a continuously variable electric drivetrain comprising a motor/generator and a ball-type continuously variable planetary having a first traction ring assembly and a second traction ring assembly in contact with a plurality of balls;
a differential coupled to the continuously variable electric drivetrain;
a drive wheel axle operably coupled to the differential;
a first wheel and a second wheel coupled to the drive wheel axle; and
a planetary gear set coupled to the continuously variable planetary, the planetary gear set comprising a ring gear coupled to the second traction ring assembly, a planet carrier adapted to receive a rotational power, and a sun gear coupled to the first traction ring assembly.

5. The electric axle powertrain of claim 4, further comprising a transfer gear set having a first transfer gear operably coupled to the planetary gear set and a second transfer gear operably coupled to the differential.

6. The electric axle powertrain of claim 5, further comprising an engagement collar operably coupled to the first transfer gear, the ring gear, and the planet carrier.

7. The electric axle powertrain of claim 6, wherein the engagement collar is adapted to move axially.

8. The electric axle powertrain of claim 6, wherein the engagement collar is an annual ring having an inner bore, wherein the inner bore is provided with a first array of engagement splines and a second array of engagement splines.

9. The electric axle powertrain of claim 8, wherein the first transfer gear is provided with a first array of engagement teeth adapted to interlock with the first array of engagement splines and the second array of engagement splines of the engagement collar.

10. The electric axle powertrain of claim 8, wherein the ring gear is provided with a second array of engagement teeth located on an outer periphery of the ring gear, wherein the second array of engagement teeth are configured to interlock with the first array of engagement splines and the second array of engagement splines of the engagement collar.

11. The electric axle powertrain of claim 8, wherein the planet carrier is provided with a third array of engagement teeth located on an outer periphery of the planet carrier, wherein the third array of engagement teeth are configured to interlock with the first array of engagement splines and the second array of engagement splines of the engagement collar.

12. The electric axle powertrain of claim 11, wherein the electric axle powertrain operates in a neutral operating condition when the engagement collar is decoupled from the first transfer gear.

13. The electric axle powertrain of claim 11, wherein the electric axle powertrain operates in a fixed ratio operating mode when the engagement collar is coupled to first transfer gear, the ring gear, and the planet carrier.

14. The electric axle powertrain of claim 11, wherein the electric axle powertrain operates in a variable ratio operating mode when he engagement collar is coupled to the first transfer gear and the ring gear.

15. The electric axle powertrain of claim 1, further comprising a planetary gear set coupled to the continuously variable planetary, the planetary gear set comprising a ring gear coupled to the mode selection mechanism, a planet carrier adapted to receive a rotational power, the planet carrier coupled to the first traction ring assembly, and a sun gear coupled to the second traction ring assembly.
